(19) United States
(12) Patent Application Publication
(10) Pub. No.: US 2023/0408145 A1
(43) Pub. Date: Dec. 21, 2023

(54) WATER TANK ASSEMBLY OF HEATING DEVICE, AND HEATING DEVICE

(71) Applicant: WUHU MIDEA KITCHEN AND BATH APPLIANCES MFG. CO., LTD., Wuhu (CN)

(72) Inventors: Yuehua CHEN, Wuhu (CN); Zitian WU, Wuhu (CN); Guorong LIANG, Wuhu (CN); Jiqing MA, Wuhu (CN)

(73) Assignee: WUHU MIDEA KITCHEN AND BATH APPLIANCES MFG. CO., LTD., Wuhu (CN)

(21) Appl. No.: 18/239,422

(22) Filed: Aug. 29, 2023

Related U.S. Application Data
(63) Continuation of application No. PCT/CN2022/114349, filed on Aug. 23, 2022.

(30) Foreign Application Priority Data
Aug. 23, 2021 (CN) 202110969677.6

(51) Int. Cl. F24H 1/14; F24H 9/00; F28F 9/02

(52) U.S. Cl. CPC F24H 1/14; F24H 9/0026; F28F 9/0246

(57) ABSTRACT

A water tank assembly and a heating device are provided. The water tank assembly has a tank body, a main heat exchange pipe assembly and a condenser pipe assembly, and a heat exchange fin assembly. The tank body has a smoke inlet and a smoke outlet. The main heat exchange pipe assembly and the condenser pipe assembly are disposed in the tank body. The main heat exchange pipe assembly has a layer of heat exchange pipes closest to the smoke inlet as a first layer of heat exchange pipes. The heat exchange pipes of the first layer are in communication with each other to form a series of water passageway. The main heat exchange pipe assembly and the condenser pipe assembly at least partially pass through the heat exchange fin assembly.

### CROSS-REFERENCE TO RELATED APPLICATIONS

This application is a continuation application of PCT International Application No. PCT/CN2022/114349, filed on Aug. 23, 2022, which claims priority to Chinese Patent Application No. 202110969677.6, titled “WATER TANK ASSEMBLY OF HEATING DEVICE, AND HEATING DEVICE”, and filed on Aug. 23, 2021, the entire contents of each of which are incorporated herein by reference for all purposes. No new matter has been introduced.

### FIELD

The present disclosure relates to the field of heating device technologies, and more particularly, to a water tank assembly of a heating device and the heating device having the same.

### BACKGROUND

A heating device using the full premix technology is increasingly valued by consumers, since it has lower smoke emissions and is thus more environmentally friendly. As a core component of the heating device, a water tank assembly is a conversion device for converting cold water into hot water.

In the related art, when the heating device operates, condensed water would generate in the water tank assembly and can corrode the water tank assembly due to its corrosivity, which may shorten the service life of the water tank assembly. An existing water tank assembly has a parallel water passageway, and thus such a design is unreasonable. In some heat exchange pipes, a water flow rate or a water flow velocity is not uniform, which leads to a phenomenon of partial empty pipes or water siltation in some heat exchange pipes having a relatively small water flow rate and a relatively slow water flow velocity. This easily cause a wall surface of the heat exchange pipes to have overly high temperature, water in the heat exchange pipes is vaporized, and a formation of scale in the heat exchange pipes is accelerated. As a result, thermal effect may occur in the heat exchange pipes, which would damage the heat exchange pipes, and will result in a water leakage of the heat exchange pipes in severe cases, thereby shortening service lives of the water tank assembly and the heating device.

### SUMMARY

The present disclosure aims to solve at least one of the technical problems in the related art. To this end, embodiments of the present disclosure provide a water tank assembly of a heating device. The water tank assembly of the heating device is in communication with a corresponding first water box and a corresponding second water box via a first layer of heat exchange pipes to form a serial water passageway. Compared with the related art, in the present disclosure, a water flow rate or a water flow velocity in a main heat exchange pipe assembly and a condenser pipe assembly is more uniform, water vaporization and scaling in the main heat exchange pipe assembly and the condenser pipe assembly can be alleviated, thereby reducing a risk of damages to a first heat exchange pipe and a second heat exchange pipe. Therefore, service lives of the water tank assembly and the heating device can be prolonged.

Embodiments of the present disclosure further provide a heating device.

A water tank assembly of a heating device according to the present disclosure includes: a tank body having a smoke inlet and a smoke outlet, in which the tank body includes a first side plate and a second side plate opposite to the first side plate; a condenser pipe assembly disposed in the tank body and located at a side of the tank body that faces towards the smoke outlet inside the tank body; a main heat exchange pipe assembly disposed in the tank body, in which the main heat exchange pipe assembly includes a layer of heat exchange pipes closest to the smoke inlet as a first layer of heat exchange pipes, and the heat exchange pipes of the first layer are in communication with one another to form a serial water passageway; and a heat exchange fin assembly, in which the main heat exchange pipe assembly and the condenser pipe assembly at least partially pass through the heat exchange fin assembly.

With the water tank assembly of the heating device according to the present disclosure, the heat exchange pipes of the first layer is in communication with one another to form the serial water passageway. Compared with the related art, in the present disclosure, the water flow rate or the water flow velocity in the main heat exchange pipe assembly and the condenser pipe assembly is more uniform, and the water vaporization and the scaling in the main heat exchange pipe assembly and the condenser pipe assembly can be alleviated, thereby reducing a risk of damages to the main heat exchange pipe assembly and the condenser pipe assembly. Therefore, the service lives of the water tank assembly and the heating device can be prolonged.

In some embodiments of the present disclosure, a plurality of first water boxes are disposed on the first side plate, and a plurality of second water boxes are disposed on the second side plate. Each of a water inlet and a water outlet of the water tank assembly is formed on the first side plate, and is in communication with one, corresponding to each of the water inlet and the water outlet, of the plurality of first water boxes.

In some embodiments of the present disclosure, the plurality of first water boxes and the plurality of second water boxes are in communication with each other via the main heat exchange pipe assembly and the condenser pipe assembly. The main heat exchange pipe assembly includes a plurality of first heat exchange pipes. The condenser pipe assembly includes a plurality of second heat exchange pipes. The plurality of first heat exchange pipes or the plurality of second heat exchange pipes is arranged in layers in a direction from the smoke inlet to the smoke outlet.

In some embodiments of the present disclosure, the tank body further includes a first heat insulation plate and a second heat insulation plate opposite to the first heat insulation plate. The first heat insulation plate and the second heat insulation plate are engaged with and connected to the first side plate and the second side plate, respectively.

In some embodiments of the present disclosure, the tank body further includes a smoke baffle engaged with and connected to the first side plate, the second side plate, the first heat insulation plate, and the second heat insulation plate. The smoke outlet is formed on the smoke baffle.

In some embodiments of the present disclosure, each of the plurality of first water boxes has an open side. Each of the plurality of second water boxes has an open side. The tank body further includes a first bottom plate and a second bottom plate. The first bottom plate cooperates with the first side plate to cover the open side of each of the plurality of first water boxes, and the second bottom plate cooperates with the second side plate to cover the open side of each of the plurality of second water boxes.

In some embodiments of the present disclosure, at least some of the plurality of first heat exchange pipes or at least some of the plurality of second heat exchange pipes each have an elliptic cross section.

In some embodiments of the present disclosure, the plurality of first heat exchange pipes of the main heat exchange pipe assembly are arranged in two layers in the direction from the smoke inlet to the smoke outlet.

In some embodiments of the present disclosure, a disturbance member is disposed on the heat exchange fin assembly and configured to divert smoke, and the disturbance member includes a flange disposed on the heat exchange fin assembly.

In some embodiments of the present disclosure, the heat exchange fin assembly includes a plurality of first fins arranged sequentially in a length direction of each of the plurality of first heat exchange pipes. Each of the plurality of first fins has a through hole, and the first heat exchange pipe passes through the through hole.

In some embodiments of the present disclosure, each of the plurality of first fins further includes a second sub-fin disposed on a side wall of the tank body and attached to an inner surface of the first heat insulation plate or the second heat insulation plate.

In some embodiments of the present disclosure, the water tank assembly of the heating device is made of a stainless steel material. Each of the first side plate, the second side plate, the first heat insulation plate, and the second heat insulation plate is an integrally-formed piece.

A heating device according to embodiments of the present disclosure includes the water tank assembly as described above.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

FIG. 1 is a cross-sectional view of a heating device according to an embodiment of the present disclosure.

FIG. 2 is a schematic view of a water tank assembly of a heating device according to an embodiment of the present disclosure.

FIG. 3 is another schematic view of a water tank assembly of a heating device according to an embodiment of the present disclosure in another direction.

FIG. 4 is a bottom view of a water tank assembly of a heating device according to an embodiment of the present disclosure.

FIG. 5 is a side view of a water tank assembly of a heating device according to an embodiment of the present disclosure.

FIG. 6 is a partial sectional view of a water tank assembly of a heating device according to an embodiment of the present disclosure.

FIG. 7 is a schematic view of a first sub-fin of a water tank assembly of a heating device according to an embodiment of the present disclosure.

FIG. 8 is a schematic view of a second sub-fin of a water tank assembly of a heating device according to an embodiment of the present disclosure.

FIG. 9 is a schematic view of another embodiment of a smoke baffle of a water tank assembly of a heating device according to an embodiment of the present disclosure.

### DETAILED DESCRIPTION

It should be noted that embodiments in the present disclosure and features in the embodiments can be combined with each other without conflict.

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, it should be understood that the orientation or position relationship indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc., is based on the orientation or position relationship shown in the drawings, and is only for the convenience of describing the present disclosure and simplifying the description, rather than indicating or implying that the pointed apparatus or element must have a specific orientation, or be constructed and operated in a specific orientation, and therefore cannot be understood as a limitation to the present disclosure. In addition, the features associated with “first” and “second” may explicitly or implicitly include one or more of the features. In the description of the present disclosure, “plurality” means at least two, unless otherwise specifically defined.

In the description of the present disclosure, it should be noted that terms such as “installed”, “connected”, and “coupled” should be understood in a broad sense, unless otherwise clearly specified and limited. For example, it may be a fixed connection or a detachable connection or connection as one piece; mechanical connection or electrical connection; direct connection or indirect connection through an intermediate; or internal communication of two components. For those of ordinary skill in the art, the specific meaning of the above-mentioned terms in the present disclosure can be understood according to specific circumstances.

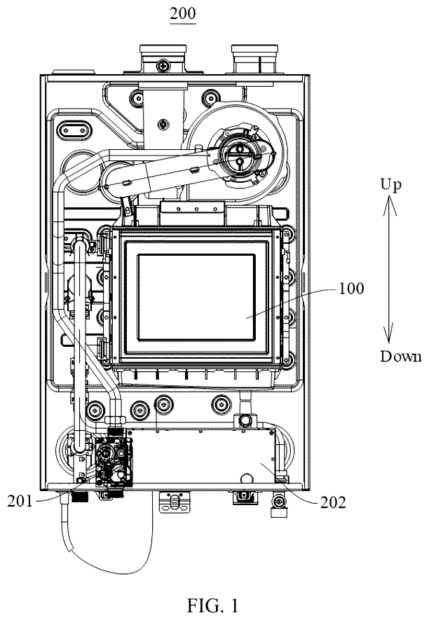

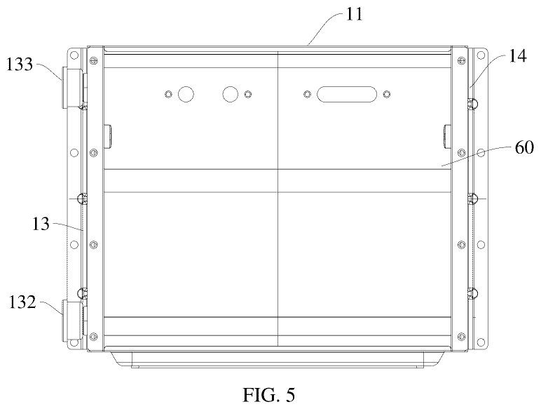

A heating device 200 according to an embodiment of the present disclosure is described below with reference to FIG. 1 to FIG. 9. The heating device 200 includes a water tank assembly 100, and may be provided as a water heater or a wall-mounted oven.

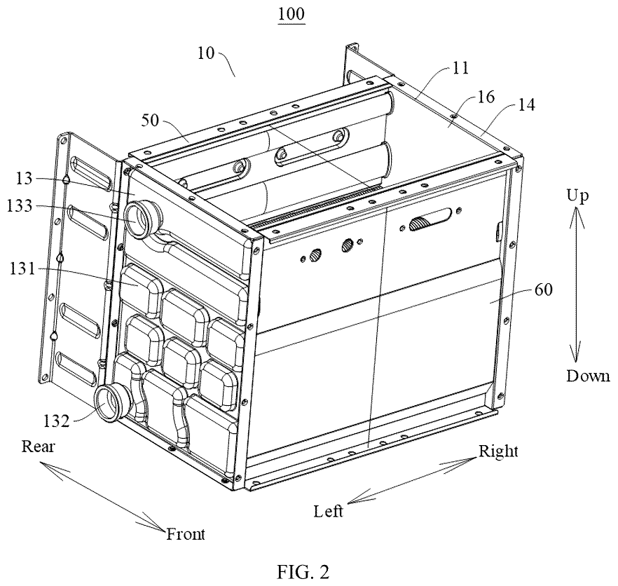

As illustrated in FIG. 1 to FIG. 9, the water tank assembly 100 according to an embodiment of the present disclosure includes a tank body 10, a main heat exchange pipe assembly 20, a heat exchange fin assembly 40, and a condenser pipe assembly 30. The tank body has a smoke outlet 12 and a smoke inlet 11. A burner may be provided for the heating device 200. High-temperature smoke generated by combustion in the burner may flow into the tank body 10 from the smoke inlet 11. The high-temperature smoke in the tank body 10 may flow out of the tank body 10 from the smoke outlet 12. The tank body 10 includes a second side plate 14. The tank body 10 further includes a first side plate 13. The second side plate 14 and the first side plate 13 are opposite to each other in a first direction of the water tank assembly 100. The first direction of the water tank assembly 100 may refer to a left-right direction in FIG. 2. The second side plate 14 and the first side plate 13 are spaced apart from each other in the first direction of the water tank assembly 100. The first side plate 13 is formed as an integrally-formed piece. The second side plate 14 is formed as an integrally-formed piece. That is, both the first side plate 13 and the second side plate 14 are formed as integrally-formed pieces. In this way, it is possible to facilitate manufacturing and production of the second side plate 14 and the first side plate 13, and improve manufacturing efficiency of the second side plate 14 and the first side plate 13. Thus, manufacturing efficiency of the water tank assembly 100 can be improved. In addition, the number of molds developed to manufacture the tank body 10 can be reduced, and manufacturing costs of the tank body 10 can be lowered. As a result, manufacturing costs of the water tank assembly 100 can be lowered.

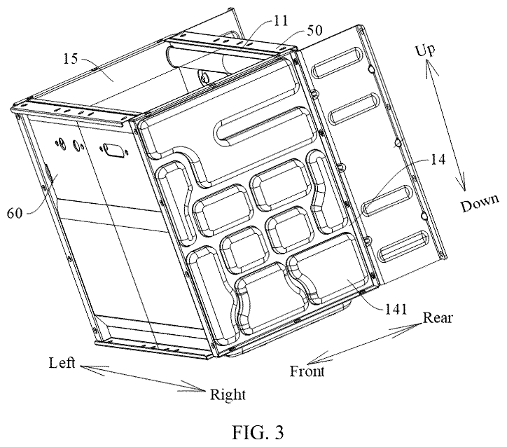

Further, as illustrated in FIG. 2 and FIG. 3, a plurality of first water boxes 131 are disposed on the first side plate 13. A plurality of second water boxes 141 are disposed on the second side plate 14. A water outlet 133 and a water inlet 132 are formed on the first side plate 13. The water inlet 132 is in communication with one of the plurality of first water boxes 131. The water outlet 133 is in communication with one of the plurality of first water boxes 131. Further, as illustrated in FIG. 2, in an up-down direction in FIG. 2, some of the plurality of first water boxes 131 are located at a same level, and some of the plurality of first water boxes 131 are located at different levels. The water outlet 133 is located at a higher level than the water inlet 132. That is, the water outlet 133 is disposed above the water inlet 132. As illustrated in FIG. 3, in an up-down direction in FIG. 3, some of the plurality of second water boxes 141 are located at a same level, and some of the plurality of second water boxes 141 are located at different levels.

The condenser pipe assembly 30 is located at a side of the main heat exchange pipe assembly 20 facing towards the smoke outlet 12. It should also be understood that, in the up-down direction in FIG. 2, the main heat exchange pipe assembly 20 is disposed at an upper side of the condenser pipe assembly 30. The plurality of second water boxes 141 and the plurality of first water boxes 131 are in communication with each other via the condenser pipe assembly 30 and the main heat exchange pipe assembly 20. The main heat exchange pipe assembly 20 includes a plurality of first heat exchange pipes 21. The condenser pipe assembly 30 includes a plurality of second heat exchange pipes 31. The plurality of first heat exchange pipes 21 are arranged in layers. The plurality of first heat exchange pipes 21 arranged in layers are arranged in a direction from the smoke inlet 11 to the smoke outlet 12. The direction from the smoke inlet 11 to the smoke outlet 12 refers to the up-down direction in FIG. 2. A first layer of heat exchange pipes 22 is a layer of heat exchange pipes closest to the smoke inlet 11. The first layer of heat exchange pipes 22 may be in communication with corresponding first water boxes 131 and corresponding second water boxes 141 to form a serial water passageway. Each of the first layer of heat exchange pipes 22 has one end in communication with the corresponding first water boxes 131 and the other end in communication with the corresponding second water boxes 141. Cold water may flow from the water inlet 132 into the first water box 131, flow upwards layer by layer through the first water boxes 131 and the second water box 141 on both sides layer by layer after passing through the second heat exchange pipe 31, and then flow through the first heat exchange pipe 21. Finally, hot water flows out of the water outlet 133.

After the high-temperature smoke generated by the combustion in the burner flows into the tank body 10, the high-temperature smoke in the tank body 10 flows through the main heat exchange pipe assembly 20. Heat from the high-temperature smoke is transferred to the cold water in the first heat exchange pipes 21. The cold water in the first heat exchange pipes 21 absorbs heat and is converted into hot water. Then, the smoke flowing through the main heat exchange pipe assembly 20 flows through the second heat exchange pipes 31 of the condenser pipe assembly 30. Cold water in the second heat exchange pipes 31 absorbs heat and is converted into hot water. The smoke can exchange heat with the condenser pipe assembly 30 to generate condensed water, and the condensed water can be discharged from the smoke outlet 12. In the present disclosure, the first layer of heat exchange pipes 22 can be in communication with the corresponding first water boxes 131 and the corresponding second water boxes 141 to form the serial water passageway. That is, a water passageway of a high-temperature heat exchange segment has a serial connection structure. That is, water passageways in the water tank assembly 100 are connected in series as one water passageway. Therefore, non-uniform distribution of a water flow rate and a water flow velocity within the water passageways will not occur. Compared with the related art, in the present disclosure, the water flow rate or the water flow velocity in the main heat exchange pipe assembly 20 and the condenser pipe assembly 30 is more uniform, and water vaporization and scaling in the condenser pipe assembly 30 and the main heat exchange pipe assembly 20 can be alleviated, thereby reducing a risk of damages to the first heat exchange pipe 21 and the second heat exchange pipe 31. As a result, service lives of the water tank assembly 100 and the heating device 200 can be prolonged.

Further, at least some of the first heat exchange pipes 21 and/or at least some of the second heat exchange pipes 31 pass through the heat exchange fin assembly 40. That is, it is possible for at least some of the plurality of first heat exchange pipes 21 to pass through the heat exchange fin assembly 40, or it is possible for at least some of the plurality of second heat exchange pipes 31 to pass through the heat exchange fin assembly 40, or it is possible for the first heat exchange pipes 21 and the second heat exchange pipes 31 to pass through the heat exchange fin assembly 40. The heat exchange fin assembly 40 may be disposed in the tank body 10. When the high-temperature smoke generated through the combustion in the burner flows into the tank body 10 from the smoke inlet 11, heat from the high-temperature smoke may be transferred to the first heat exchange pipes 21 and/or the second heat exchange pipes 31. In this way, more heat can be transferred to the cold water in the first heat exchange pipes 21 and/or the second heat exchange pipes 31. As a result, heat exchange efficiency can be improved. Thus, the cold water can be converted into the hot water more quickly, which in turn improves heat exchange efficiency of the water tank assembly 100 and operation performance of the heating device 200.

Therefore, by communicating the first layer of heat exchange pipes 22 with the first water boxes 131 and the second water boxes 141 to form a serial water passageway, in the present disclosure, compared with the related art, the water flow rate or the water flow velocity in the condenser pipe assembly 30 and the main heat exchange pipe assembly 20 is more uniform, and the water vaporization and the scaling in each of the condenser pipe assembly 30 and the main heat exchange pipe assembly 20 can be alleviated, thereby reducing the risk of damage to the first heat exchange pipes 21 and the second heat exchange pipes 31. Therefore, the service lives of the water tank assembly 100 and the heating device 200 can be prolonged.

In some embodiments of the present disclosure, as illustrated in FIG. 2, the tank body 10 may further include a second heat insulation plate 60 and a first heat insulation plate 50. The second heat insulation plate 60 is opposite to the first heat insulation plate 50. The first heat insulation plate 50 is engaged with and connected to the second side plate 14 and the first side plate 13. The second heat insulation plate 60 is engaged with and connected to the second side plate 14 and the first side plate 13. Further, as illustrated in FIG. 2, the first heat insulation plate 50 has a left end connected to the first side plate 13 and a right end connected to the second side plate 14. The second heat insulation plate 60 has a left end connected to the first side plate 13 and a right end connected to the second side plate 14. The second heat insulation plate 60 and the first heat insulation plate 50 can provide heat insulation. When the high-temperature smoke generated through the combustion in the burner flows into the tank body 10 from the smoke inlet 11, it is possible to prevent the heat from being transferred to the outside of the tank body 10 from the second heat insulation plate 60 and the first heat insulation plate 50. Thus, dissipation of the heat from the second heat insulation plate 60 and the first heat insulation plate 50 can be avoid, which can therefore ensure the heat exchange efficiency of the water tank assembly 100. Therefore, heating efficiency of the heating device 200 can be ensured.

Further, each of the second heat insulation plate 60 and the first heat insulation plate may be formed as an integrally-formed piece. The integrally-formed piece has high structural strength, and thus structural strength of the second heat insulation plate 60 and the first heat insulation plate 50 can be enhanced. As a result, it is possible to avoid a deformation of the tank body 10. In addition, manufacturing and production of the second heat insulation plate 60 and the first heat insulation plate 50 can be facilitated to improve the manufacturing efficiency of the second heat insulation plate 60 and the first heat insulation plate 50, which can further increase the manufacturing efficiency of the water tank assembly 100. Moreover, the number of molds developed to manufacture the tank body 10 can be reduced, which can further lower manufacturing costs of the tank body 10. Therefore, the manufacturing costs of the water tank assembly 100 can be lowered.

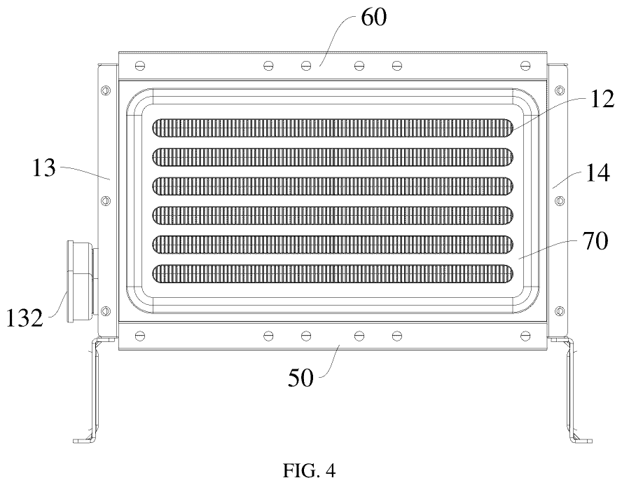

In some embodiments of the present disclosure, as illustrated in FIG. 4, the tank body 10 can further include a smoke baffle 70. The smoke baffle 70 may be formed as a one-piece member. That is, the smoke baffle 70 is formed as an integrally-formed piece. The smoke baffle is engaged with and connected to the second side plate 14, the first side plate 13, the second heat insulation plate 60, and the first heat insulation plate 50. The smoke outlet 12 may be formed on the smoke baffle 70. As illustrated in FIG. 4, the smoke baffle 70 is engaged with and connected to a lower end of each of the second side plate 14, the first side plate 13, the second heat insulation plate 60, and the first heat insulation plate 50. When the high-temperature smoke generated through the combustion in the burner flows into the tank body 10 from the smoke inlet 11, the smoke baffle 70 can block the smoke when the smoke flows to the smoke baffle 70, which can extend a duration for which the smoke flows out from the smoke outlet 12 to enable the smoke to stay longer in the tank body 10. In this way, a duration for the high-temperature smoke to exchange heat with the first heat exchange pipe 21, the second heat exchange pipe 31, and the heat exchange fin assembly 40 can be prolonged to allow more heat to heat cold water, which reduces a heat loss and improves the heating efficiency of the heating device 200.

In some embodiments of the present disclosure, as illustrated in FIG. 4, the smoke outlet 12 may include a plurality of through holes. The plurality of through holes may each be formed into an elongated structure and arranged at intervals evenly. In this way, a flow area of the smoke can be ensured to allow the smoke to flow out of the tank body 10 from the smoke outlet 12 smoothly, thereby avoiding an expansion damage to the tank body 10 due to an excessive pressure in the tank body 10. An explosion of the tank body 10 can therefore be avoided, which can improve use safety of the heating device 200. However, the present disclosure is not limited in this regard. The smoke outlet 12 may include a plurality of through holes of a round shape, an elliptic shape, a trapezoidal shape, or other shapes, as long as the shape of the through hole can function as an elongated shape.

In some embodiments of the present disclosure, the plurality of first water boxes 131 are opened at a same side, and the plurality of second water boxes 141 are opened at a same side. Further, each of the plurality of first water boxes 131 has an open side facing towards an inside of the tank body 10, and each of the plurality of second water boxes 141 has an open side facing towards the inside of the tank body 10. As illustrated in FIG. 2, the plurality of first water boxes 131 are opened at a right side, and the plurality of second water boxes 141 are opened at a left open side. The tank body 10 may further include a second bottom plate 16 and a first bottom plate 15. Each of the first bottom plate 15 and the second bottom plate 16 may be formed as an integrally-formed piece. The first bottom plate 15 can cooperate with the first side plate 13 to cover the open side of each of the plurality of first water boxes 131. The second bottom plate 16 can cooperate with the second side plate 14 to cover the open side of each of the plurality of second water boxes 141.

Further, a plurality of first bottom plates 15 may be provided and arranged in one-to-one correspondence to the plurality of first water boxes 131. A plurality of second bottom plates 16 may be provided and arranged in one-to-one correspondence to the plurality of second bottom plates. A mounting hole is formed on each of the plurality of first bottom plates 15 and each of the plurality of second bottom plates 16. The mounting hole penetrates corresponding first bottom plates 15, and the mounting hole penetrates corresponding second bottom plates 16. The first heat exchange pipe 21 and the second heat exchange pipe 31 each are mounted in the corresponding mounting holes. In this way, it can be ensured that water in the first water boxes 131 flows into the first heat exchange pipes 21 and the second heat exchange pipes 31. In addition, it is possible to ensure that water in the second water boxes 141 flows into the first heat exchange pipes 21 and the second heat exchange pipes 31. Thus, it is possible to prevent the water from flowing out of the open sides of the first water boxes 131 and the open sides of the second water boxes 141, thereby avoiding water leakage of the water tank assembly 100.

The first bottom plates 15 may be formed into an integral plate-like structure. One first bottom plates 15 can cover the open sides of the plurality of first water boxes 131 simultaneously. The second bottom plates 16 may be formed in an integral plate-like structure. One second bottom plate 16 can cover the open sides of the plurality of second water boxes 141 simultaneously.

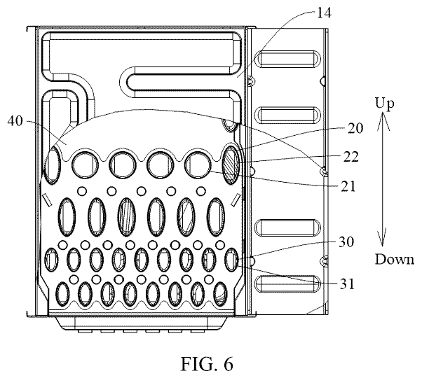

In some embodiments of the present disclosure, as illustrated in FIG. 6, the second heat exchange pipe 31 has an elliptic cross section. Further, the second heat exchange pipe 31 has an elliptic cross section. That is, the cross section of the second heat exchange pipe 31 is an elliptic shape. If flowing in the second heat exchange pipe 31 at an overly low flow velocity and with overly high flow resistance, the water will be easily vaporized in the second heat exchange pipe 31 or scale will be formed in the second heat exchange pipe 31, which may affect the performance and the service life of the heating device 200. Therefore, by designing the second heat exchange pipe 31 to have the elliptic cross section, the flow resistance of the water in the second heat exchange pipe 31 can be reduced when the water flows in the second heat exchange pipe 31, which can avoid deposition of insoluble substances in the second heat exchange pipe 31. As a result, it is possible to avoid vaporization of the water in the second heat exchange pipe 31, and alleviate the formation of the scale in the second heat exchange pipe 31, thereby improving the performance of the heating device 200 and prolonging the service life of the heating device 200. However, the present disclosure is not limited in this regard. The second heat exchange pipe 31 may have other irregularly-shaped cross sections, as long as the cross section of the second heat exchange pipe 31 can function as the elliptic cross section.

In some embodiments of the present disclosure, as illustrated in FIG. 6, at least some of the plurality of first heat exchange pipes 21 each have an elliptic cross section. If flowing in the first heat exchange pipe 21 at an overly low flow velocity and with overly high flow resistance, the water will be easily vaporized in the first heat exchange pipe 21 or scale will be formed in the first heat exchange pipe 21, which may affect the performance and the service life of the heating device 200. Therefore, by design each of the at least some of the plurality of first heat exchange pipes 21 to have the elliptic cross section, the flow resistance of the water in the first heat exchange pipe 21 can be reduced when the water flows in the first heat exchange pipe 21, which can avoid deposition of the insoluble substances in the first heat exchange pipe 21. As a result, it is possible to avoid vaporization of the water in the first heat exchange pipe 21, and alleviate the formation of the scale in the first heat exchange pipe 21, thereby further improving the performance of the heating device 200 and prolonging the service life of the heating device 200. However, the present disclosure is not limited in this regard. The first heat exchange pipe 21 may have other irregularly-shaped cross sections, as long as the cross section of the first heat exchange pipe 21 can function as the elliptic cross section.

In some embodiments of the present disclosure, as illustrated in FIG. 6, the plurality of first heat exchange pipes 21 are arranged in two layers in the direction from the smoke inlet 11 to the smoke outlet 12. Some of the plurality of first heat exchange pipes 21 in the first layer of heat exchange pipes 22 each have an elliptic cross section, while the rest of the plurality of first heat exchange pipes 21 in the first layer of heat exchange pipes 22 each have a circular cross section. A second layer of heat exchange pipes is disposed below the first layer of heat exchange pipes 22. Each first heat exchange pipe 21 in the second layer of heat exchange pipes 22 has an elliptic cross section. When the water flows in the plurality of first heat exchange pipes 21, the flow resistance of the water in the first heat exchange pipe 21 can be further reduced, which can further avoid the deposition of the insoluble substances in the first heat exchange pipe 21. As a result, it is possible to further avoid the vaporization of the water in the first heat exchange pipe 21, and further alleviate the formation of the scale in the first heat exchange pipe 21, thereby further improving the performance of the heating device 200 and prolonging the service life of the heating device 200.

In some embodiments of the present disclosure, a disturbance member may be disposed on the heat exchange fin assembly 40. The disturbance member is configured to divert the smoke in the tank body 10. When the high-temperature smoke generated through the combustion in the burner flows into the tank body 10 from the smoke inlet 11, the smoke in the tank body 10 can be diverted by the disturbance member to prolong movement time of the smoke in the tank body 10. Thus, sufficient heat exchange can be performed between the smoke and the heat exchange fin assembly 40, the first heat exchange pipe 21, and the second heat exchange pipe 31, which in turn can enhance the heating efficiency of the heating device 200 and improve the operation performance of the heating device 200.

In some embodiments of the present disclosure, the disturbance member may include a flange disposed on the heat exchange fin assembly 40. In this way, a structure of the disturbance member can be simplified to facilitate manufacturing and production of the disturbance member, thereby improving manufacturing efficiency of the disturbance member. Further, the disturbance member and the heat exchange fin assembly 40 may be integrally formed. That is, the disturbance member and the heat exchange fin assembly 40 are provided as an integrally-formed piece. In this way, the number of parts for forming the water tank assembly 100 can be reduced to improve assembly efficiency of the water tank assembly 100, thereby improving the manufacturing efficiency of the water tank assembly 100.

In some embodiments of the present disclosure, as illustrated in FIG. 2, FIG. 3, and FIG. 6, the heat exchange fin assembly 40 may include a plurality of first fins arranged sequentially in a length direction of the first heat exchange pipe 21. The length direction of the first heat exchange pipe 21 refers to the left-right direction in FIG. 2. Each first fin may have a through hole 42. The through hole 42 penetrates the first fin in a thickness direction of the first fin. The first heat exchange pipe 21 passes through the through hole 42. In this way, the technical solution that the first heat exchange pipe 21 passes through the first fin can be realized to prevent separation of the first fin from the first heat exchange pipe 21. As a result, heat exchange between the first heat exchange pipe 21 and the first fin can be ensured. In addition, by providing the plurality of first fins, heat exchange efficiency between the heat exchange fin assembly 40 and the first heat exchange pipe 21 can be improved.

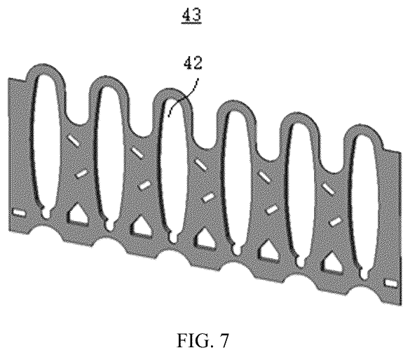

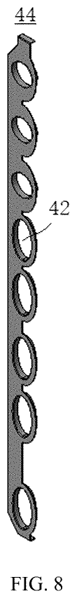

In some embodiments of the present disclosure, as illustrated in FIG. 7 and FIG. 8, the first fin includes a first sub-fin 43 and a second sub-fin 44. The first sub-fin 43 may be sleeved over the first heat exchange pipe 21, and the second sub-fin 44 may also be sleeved over the first heat exchange pipe 21. In addition, the second sub-fin 44 is disposed on a side wall of the tank body 10. For example, the second sub-fin 44 is disposed on an inner surface of the first heat insulation plate 50, which can enlarge a heat exchange area of the heat exchange fin assembly 40.

In some embodiments of the present disclosure, the water tank assembly 100 may be made of a stainless steel material. In this way, it is possible to effectively enhance corrosion resistance of the water tank assembly 100, thereby further prolonging the service life of the water tank assembly 100.

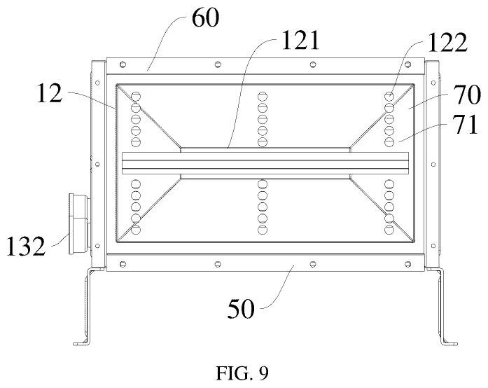

In some embodiments of the present disclosure, as illustrated in FIG. 9, the smoke baffle 70 may include a plurality of guide plates 71 facing away from the smoke inlet 11. The smoke outlet 12 includes a first channel 121. Ends of the plurality of guide plates 71 facing away from the smoke inlet 11 are spaced apart from each other to define the first channel 121. The smoke in the tank body 10 can flow out of the tank body 10 through the first channel 121. In this way, the flow area of the smoke can be ensured to allow the smoke to flow out of the tank body from the smoke outlet 12 smoothly, thereby avoiding the expansion damage to the tank body due to the excessive pressure in the tank body 10. As a result, the explosion of the tank body can therefore be avoided, which can improve the use safety of the heating device 200.

Further, as illustrated in FIG. 9, the smoke outlet 12 may further include a second channel 122. A plurality of second channels 122 may be formed on each guide plate 71. The second channel 122 penetrates the guide plate 71 in a thickness direction of the guide plate 71. The smoke in the tank body 10 can flow out of the tank body 10 through the second channel 122. In this way, the flow area of the smoke can be enlarged to allow the smoke in the tank body 10 to flow out of the tank body 10 through the first channel 121 and the second channel 122. Further, it is also possible to ensure the smoke flows out of the tank body 10 from the smoke outlet 12 smoothly, thereby further avoiding the expansion damage to the tank body 10 due to the excessive pressure in the tank body 10. As a result, the explosion of the tank body 10 can be further avoided, which can further improve the use safety of the heating device 200.

FIG. 1 to FIG. 6 illustrate a heating device 200 according to the embodiments of the present disclosure. The heating device 200 may be a water heater or a wall-mounted oven, and includes the water tank assembly 100 as described in the above embodiments. The water tank assembly 100 is disposed on the heating device 200. The first layer of heat exchange pipes 22 are in communication with the first water boxes 131 and the second water boxes 141 to form the serial water passageway. Compared with the related art, in the present disclosure, the water flow rate or the water flow velocity in the main heat exchange pipe assembly 20 and the condenser pipe assembly 30 is more uniform, and the water vaporization and the scaling in the condenser pipe assembly 30 and the main heat exchange pipe assembly 20 can be alleviated, thereby reducing the risk of damages to the first heat exchange pipe 21 and the second heat exchange pipe 31 and prolonging the service lives of the water tank assembly 100 and the heating device 200.

Other components, such as a smoke valve 201 and a controller 202 and other operations of the heating device 200 according to the embodiments of the present disclosure, are known to those of ordinary skill in the art, and thus the description thereof in detail will be omitted here.

In the description of this specification, description with reference to the terms “an embodiment”, “some embodiments”, “exemplary embodiments”, “examples” “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A water tank assembly of a heating device, the water tank assembly comprising:
a tank body having a smoke inlet and a smoke outlet, the tank body comprising a first side plate and a second side plate opposite to the first side plate;
a condenser pipe assembly disposed in the tank body and located at a side of the tank body, wherein the side of the tank body faces towards the smoke outlet;
a main heat exchange pipe assembly disposed in the tank body, heat exchange pipes of the main heat exchange pipe assembly closest to the smoke inlet being a first heat exchange pipe layer, the heat exchange pipes of the first heat exchange pipe layer being in communication with one another to form a serial water passageway; and
a heat exchange fin assembly, the main heat exchange pipe assembly and the condenser pipe assembly at least partially passing through the heat exchange fin assembly.

2. The water tank assembly of the heating device according to claim 1, wherein:
a plurality of first water boxes are disposed on the first side plate;
a plurality of second water boxes are disposed on the second side plate; and
each of a water inlet and a water outlet of the water tank assembly is formed on the first side plate, and is in communication with one, corresponding to each of the water inlet and the water outlet, of the plurality of first water boxes.

3. The water tank assembly of the heating device according to claim 1, wherein:
the plurality of first water boxes and the plurality of second water boxes are in communication with each other via the main heat exchange pipe assembly and the condenser pipe assembly;
the main heat exchange pipe assembly comprises a plurality of first heat exchange pipes;
the condenser pipe assembly comprises a plurality of second heat exchange pipes; and
the plurality of first heat exchange pipes or the plurality of second heat exchange pipes are arranged in layers in a direction from the smoke inlet to the smoke outlet.

4. The water tank assembly of the heating device according to claim 1, wherein:
the tank body further comprises a first heat insulation plate and a second heat insulation plate opposite to the first heat insulation plate; and
the first heat insulation plate and the second heat insulation plate are engaged with and connected to the first side plate and the second side plate, respectively.

5. The water tank assembly of the heating device according to claim 4, wherein:
the tank body further comprises a smoke baffle engaged with and connected to the first side plate, the second side plate, the first heat insulation plate, and the second heat insulation plate; and
the smoke outlet is formed on the smoke baffle.

6. The water tank assembly of the heating device according to claim 1, wherein:
each of the plurality of first water boxes has an open side;
each of the plurality of second water boxes has an open side; and
the tank body further comprises a first bottom plate and a second bottom plate, the first bottom plate cooperating with the first side plate to cover the open side of each of the plurality of first water boxes, and the second bottom plate cooperating with the second side plate to cover the open side of each of the plurality of second water boxes.

7. The water tank assembly of the heating device according to claim 1, wherein:
at least one of the plurality of first heat exchange pipes has an elliptic cross section; or
at least one of the plurality of second heat exchange pipes has an elliptic cross section.

8. The water tank assembly of the heating device according to claim 3, wherein the plurality of first heat exchange pipes of the main heat exchange pipe assembly are arranged in two layers in the direction from the smoke inlet to the smoke outlet.

9. The water tank assembly of the heating device according to claim 1, wherein a disturbance member is disposed on the heat exchange fin assembly and configured to divert smoke, the disturbance member comprising a flange disposed on the heat exchange fin assembly.

10. The water tank assembly of the heating device according to claim 3, wherein the heat exchange fin assembly comprises a plurality of first fins arranged sequentially in a length direction of each of the plurality of first heat exchange pipes, each of the plurality of first fins having a through hole, and the first heat exchange pipe passing through the through hole.

11. The water tank assembly of the heating device according to claim 10, wherein each of the plurality of first fins further comprises a second sub-fin disposed on a side wall of the tank body and attached to an inner surface of the first heat insulation plate or the second heat insulation plate.

12. The water tank assembly of the heating device according to claim 4, wherein each of the first side plate, the second side plate, the first heat insulation plate, and the second heat insulation plate is an integrally-formed piece.

13. A heating device comprising the water tank assembly according to claim 1.

14. The heating device according to claim 13, wherein:
a plurality of first water boxes are disposed on the first side plate;
a plurality of second water boxes are disposed on the second side plate; and
each of a water inlet and a water outlet of the water tank assembly is formed on the first side plate, and is in communication with one, corresponding to each of the water inlet and the water outlet, of the plurality of first water boxes.

15. The heating device according to claim 13, wherein:
the plurality of first water boxes and the plurality of second water boxes are in communication with each other via the main heat exchange pipe assembly and the condenser pipe assembly;
the main heat exchange pipe assembly comprises a plurality of first heat exchange pipes;
the condenser pipe assembly comprises a plurality of second heat exchange pipes; and
the plurality of first heat exchange pipes or the plurality of second heat exchange pipes are arranged in layers in a direction from the smoke inlet to the smoke outlet.

16. The heating device according to claim 13, wherein:
the tank body further comprises a first heat insulation plate and a second heat insulation plate opposite to the first heat insulation plate; and
the first heat insulation plate and the second heat insulation plate are engaged with and connected to the first side plate and the second side plate, respectively.

17. The heating device according to claim 16, wherein:
the tank body further comprises a smoke baffle engaged with and connected to the first side plate, the second side plate, the first heat insulation plate, and the second heat insulation plate; and
the smoke outlet is formed on the smoke baffle.

18. The heating device according to claim 13, wherein:
each of the plurality of first water boxes has an open side;
each of the plurality of second water boxes has an open side; and
the tank body further comprises a first bottom plate and a second bottom plate, the first bottom plate cooperating with the first side plate to cover the open side of each of the plurality of first water boxes, and the second bottom plate cooperating with the second side plate to cover the open side of each of the plurality of second water boxes.

19. The heating device according to claim 13, wherein:
at least one of the plurality of first heat exchange pipes has an elliptic cross section; or
at least one of the plurality of second heat exchange pipes has an elliptic cross section.

20. The heating device according to claim 16, wherein the plurality of first heat exchange pipes of the main heat exchange pipe assembly are arranged in two layers in the direction from the smoke inlet to the smoke outlet.
